(19) United States
(12) Patent Application Publication
(10) Pub. No.: US 2006/0205313 A1
(43) Pub. Date: Sep. 14, 2006

(54) Forming a grid structure for a field emission device

(75) Inventor: Richard Fink, Austin, TX (US)

Correspondence Address: Kelly K. Kordzik;Winstead Sechrest & Minick P.C., P.O. Box 50784, Dallas, TX, 75201, US

(73) Assignee: Nano-Proprietary, Inc., Austin, TX (US)

(21) Appl. No.: 11/371,496

(22) Filed: Mar. 9, 2006

Related U.S. Application Data
(60) Provisional application No. 60/660,305, filed on Mar. 10, 2005.

(51) Int. Cl. H01J 9/24; H01J 9/00

(52) U.S. Cl. 445/24; 445/46

(57) ABSTRACT

A conducting mesh grid electrode for a triode structure in a field emission display is formed using a stitching or bonding process. The raw material for the grid electrode may be fed continuously from a spool. The process provides for multiple bonding of wire grid conductors to form a cathode grid. The properties of the cathode and the electron beam may be modulated by varying process parameters and material dimensions.

### CROSS REFERENCE TO RELATED APPLICATIONS

The present invention claims priority under 35 U.S.C. 119(e) to U.S. Provisional application Ser. No. 60/660,305 filed on 03/10/2005.

### TECHNICAL FIELD OF INVENTION

The present invention relates in general to field emission, and in particular to forming electrodes in field emission devices.

### BACKGROUND INFORMATION

Field emission displays are usually categorized as diode type or triode type displays. Diode type displays (see Kumar and xie, U.S. Pat. Nos. 5,449,970 and 5,612,712) are simple structures but require high switching voltages in order to operate the display, while on the other hand, the anode (phosphor) efficiencies are low due to the fact that the anode voltages are less than 1,000 V.

Triode type displays offer several advantages; the two biggest advantages are that the switching voltages can be low while the anode voltage can be held at high potentials in order to achieve high phosphor efficiencies. The problem with the triode structure is that it is much more difficult to fabricate and assemble.

In the triode type display, the matrix addressing of the electron source is between the cathode and grid electrodes. For microtip FEDs, the cathode tips and the gate structures are fabricated on the cathode plate using microfabrication techniques (Spindt and Holland, U.S. Patent No. 4,857,799). This is an expensive approach; a lower cost structure is needed.

For flat cathode field emission displays, such as carbon nanotube-based displays or other carbon based displays, the cathode and gate structure can be fabricated using printing or other microfabrication techniques. Recent examples of such displays have been demonstrated and published as references. See J. Dijon et al., “6-in. Video CNT-FED with Improved Uniformity,” Proceedings of the 12^{th} International Display Workshops, p. 1635, Takamatsu, Japan, 2005; Kunihiko Nishimura et al., “Fabrication of CNT Emitter Array with Polymer Insulator,” SID Digest of Technical Papers, p. 1612, 2005; and Jun Hee Choi et al., “Carbon nanotube field emitter arrays having an electron beam focusing structure,” Appl. Phys. Lett., vol. 84, p. 1,022, 2004. If the feature sizes of the cathode and gate are large (on the order of 25-50 microns), then the cathode and gate structures can be made by printing techniques such as screen printing, inkjet printing or other similar techniques. This leads to a low-cost fabrication process, but the large feature sizes limit the pixel density such that high resolution, small screen size displays are difficult to make. The printed structures also do not make efficient use of the cathode since the strongest fields for extracting the electrons are near the edge of the gate structure and are not uniformly distributed over the cathode area within the gate structure. The high field strengths on the dielectric wall between the gate and cathode can lead to shorting between the cathode and gate electrodes. Furthermore, this structure creates a divergent electron beam, thus making the beam spot size on the anode larger than desired, leading to color mixing and low contrast ratio between the different pixels and sub-pixels.

Another approach to making a triode structure for a flat cathode is to fabricate a metal mesh and suspend the metal mesh over the cathode emissive patches. See Eung Joon Chi et al., “CNT FEDs for Large Area and HDTV Applications,” SID International Symposium Digest of Technical Papers, p. 1620, 2005. The cathode lines and the metal mesh electrodes can be fabricated in a matrix such that the electron source array is addressable. This approach has the advantage in that the cathode can be fabricated separately from the grid. This is important especially for many carbon nanotube-based cathodes as they require a high temperature CVD growth process or the carbon material is printed or dispensed. The presence of a metal grid suspended over the cathode during carbon growth or carbon dispensing would make fabrication very complicated if not impossible. For CNT-based displays, it is best to attach the metal mesh structure after the carbon is dispensed or grown.

Using a metal mesh also provides a relatively uniform electric field over the cathode patch and does not introduce a highly diverging electron beam from the carbon patch.

One of the issues with this approach can be cost. The metal mesh is generally fabricated using photo patterning and chemical etching. This technology is well known to the manufacturers of stencil masks and CRT tension masks and shadow masks. For large displays, the metal grid structures can be a significant cost of the entire display fabrication process, while the handling of these metal grid electrodes during fabrication can be very problematic. The delicate metal mesh grids are difficult to align and can be damaged easily.

A metal grid structure is desired for use on flat cathodes or carbon based cathodes (allows for a suspended metal electrode over the carbon patch), that is easy to fabricate and low cost to manufacture, does not require difficult handling and can be easily aligned.

### SUMMARY OF THE INVENTION

The present invention addresses the foregoing needs by providing a method for forming a metal grid structure on a field-emission cathode by bonding a conductive raw material, dispensable from a spool, across the cathode well. The conductive raw material that is bonded to the cathode well may comprise a fiber, filament, strand, wire, thread or a wire or a ribbon-like material, herein collectively referred to as a wire grid. A bonding process, such as a conventional wire bonding technique, may be performed for securing the wire grid.

The present invention avoids the major cost and handling issues involving prefabricated metal grid electrodes, while providing flexibility and performance benefits. Industrial feasibility of a manufacturing process for a large number of field-emission cathodes, such as for a field-emission display devices, is enhanced by the present invention, in that, the dependence on an expensive and delicate raw material is reduced. The performance of a wire grid may be tuned by adjusting various parameters in a fabrication process, such as the wire diameter and geometry of the grid contacts. In this manner, various types of wire grids may be manufactured on substantially the same process, with minimal reconfiguration time, using the same production resources.

The foregoing has outlined rather generally the features and technical advantages of one or more embodiments of the present invention in order that the detailed description of the present invention that follows may be better understood. Additional features and advantages of the present invention will be described hereinafter which may form the subject of the claims of the present invention.

### BRIEF DESCRIPTION OF THE DRAWINGS

For a more complete understanding of the present invention, and the advantages thereof, reference is now made to the following descriptions taken in conjunction with the accompanying drawings, in which:

FIGS. 1A-1C illustrate steps in a prior art method of making a triode structure for a field-emission cathode;

FIGS. 2A-2B illustrate steps in a prior art method of making a triode structure for a field-emission cathode;

FIGS. 3A-3B illustrate steps in a prior art method of making a triode structure for a field-emission cathode;

FIG. 4 illustrates a top view of a prior art cathode grid structure;

FIGS. 5 and 6 illustrate methods of forming a grid electrode in an embodiment of the present invention;

FIG. 7 illustrates a data processing system; and

FIG. 8 illustrates a portion of a field emission display made using a cathode in a triode configuration.

### DETAILED DESCRIPTION

In the following description, numerous specific details are set forth such as specific substrate materials to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

Refer now to the drawings wherein depicted elements are not necessarily shown to scale and wherein like or similar elements are designated by the same reference numeral through the several views.

The present invention comprises an approach for forming a suspended extraction wire grid structure that overcomes the disadvantages of previous extraction grids. In one embodiment of the present invention, the wire grid structure is woven, bonded or stitched directly onto the surface of the field emitter structure. The wire grid may be formed using metal wire or a thread that is made conducting (i.e. conductive coating on a glass fiber) and then stitched or bonded to the cathode structure, such that a triode structure is created.

An analogous example of a prior art process, currently used in the electronics industry, is a wire bonding process for forming electrical connections between electrical components. Wire bonding is used, for example, for connections between contact pads on an electronic device (i.e., an integrated circuit) and contact pads on a printed circuit board or the package of the electronic device. In one example, a conducting fiber (generally Au or Al wire) is bonded on one contact pad and then spooled out over a certain distance until another bond is made, and then the fiber is cut. This bonding-spooling-bonding-cutting process can be very fast and very reliable. Wire bonding is a mature technology. A similar approach may be applied for forming a metal grid structure for a field emission display.

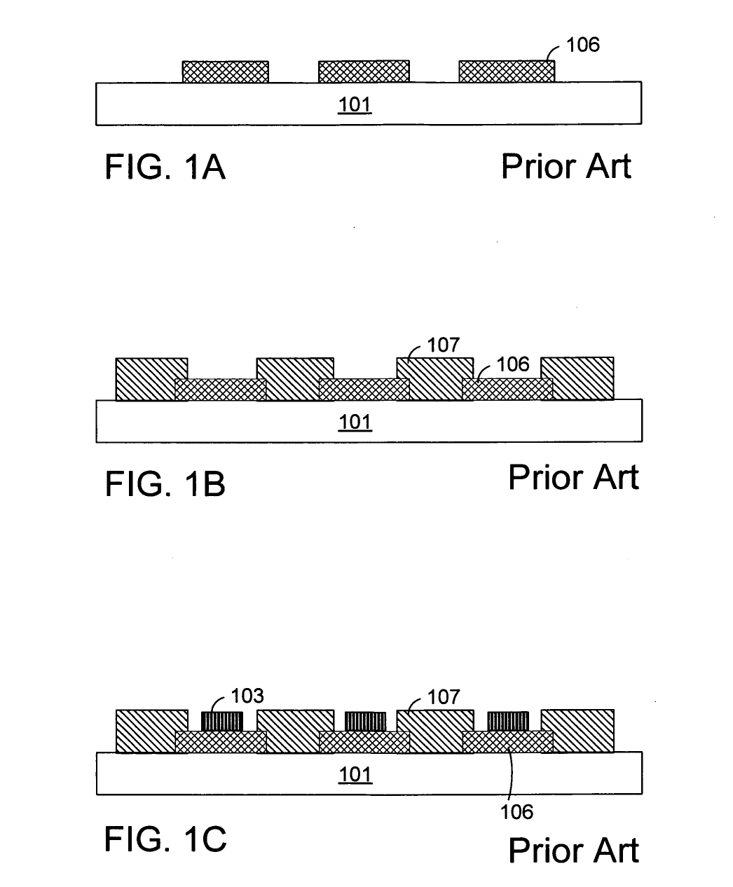

FIGS. 1A-1C, 2A-2B, and 3A-2B illustrate (in cross-section view) a prior art method of making a gated, triode structure for a carbon nanotube (CNT) cathode, in which the grid electrode is attached to the cathode after the carbon material is printed onto the cathode. FIGS. 1A-1C illustrate a schematic diagram of a cross-sectional view of the structure of the composite device and a CNT deposition process. In FIG. 1A, a 2.5 mm thick 12 inch×12 inch size glass plate was chosen as the substrate 101. Any other kind of insulating substrates, such as ceramic plates, can be used. Then, in one example, a layer of Ag electrode lines 106 were patterned onto it using a screen printing process. In one example of the present invention, the width of the Ag electrode lines 106 was 400 μm, while the gap between the nearest Ag lines was 125 μm. In another example, a total of 480 Ag electrode lines 106 were patterned on the substrate 101. Silver thick paste (acquired from Dupont#7,713) may be used as a material used to deposit the Ag electrode lines 106. The resulting composite structure was fired at 520° C. for 30 min. to remove the organic solvents in the Ag paste 106. In one example method, the thickness of the Ag electrode lines 106 was 6 microns. Next, FIG. 1B illustrates a 50 micron insulating overcoat 107 applied onto the surface of the composite structure of FIG. 1A, leaving patterned open pixels on the Ag electrode lines, as illustrated in FIG. 1B. In one case, the size of the pixels was 340 μm×1015 μm, while the distance between the nearest two pixels on the same Ag electrode line 106 was 560 μm, and 225 μm between the nearest two Ag electrode lines 106. The resulting composite structure, as shown in FIG. 1B, was fired at 520° C. for 30 min. after the insulating overcoat 107 was printed on the substrate 101 and Ag lines 106. FIG. 1C illustrates the deposition of the CNTs 103 onto the surface of the composite structure of FIG. 1B. In separate embodiments of the present invention, the CNTs 103 may be deposited over the entire coated surface using spray and screen printing methods. The invention may be practiced in other embodiments which use methods such as electrophoresis deposition, dipping, screen printing, ink-jet printing, dispensing, spin-coating, brushing or a plurality of other techniques to deposit CNTs onto the surface of the composite structure of FIG. 1B. The deposited CNT material may be in the form of an ink or paste, which may comprise fillers, binders, or other additives for altering certain properties (e.g., viscosity) of the CNT ink or paste. The properties of the CNT material may be so adjusted in optimization for a particular dispensing technology. The CNT layer may be fired and cured as required by the deposition process. In one sample, the applied thickness of the CNT layer 103 was about 2˜5 μm.

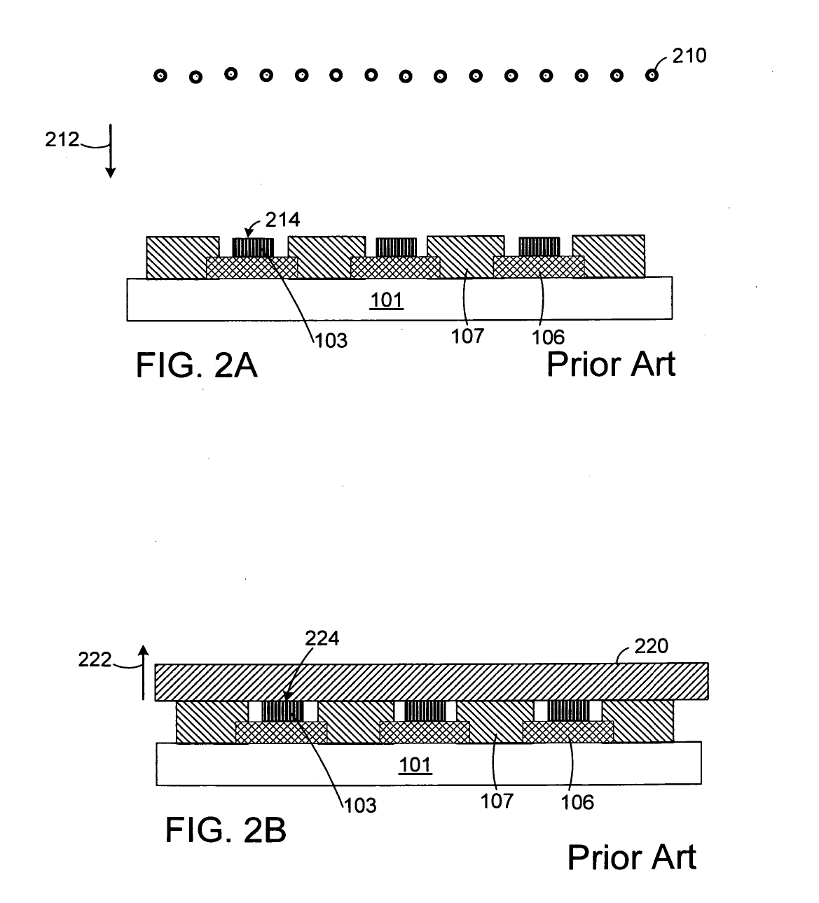

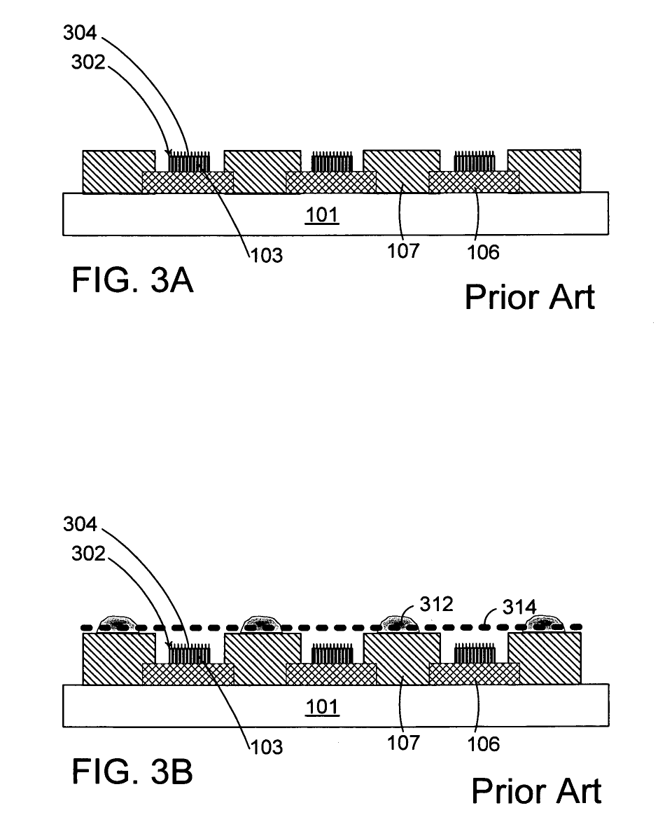

In FIGS. 2A and 2B, separate activation processes are shown for activating the CNT layer 103 for field emission. In FIG. 2A, the entire structure is bombarded by particles 210, such as beads or sand, in a direction 212 incident on the substrate composite structure. (See U.S. patent application Ser. No. 10/877,241) The result of bombardment on the CNT layer 103 is the exposure, and hence activation, of CNTs on surface 214. In an alternative activation process shown in FIG. 2B, a tape 220 is applied and adhered to the substrate composite structure, and then removed in the direction 222. Tape activation results in increased surface presence of CNT emitters on surface 224. (See U.S. Pat. No. 6,436,221) As needed, further activation may be performed using a tape, plasma, laser or sandblast activation process, or other process. In FIG. 3A, the activated structure is shown. On surface 302, an increased population of CNT emitters 304 is now present.

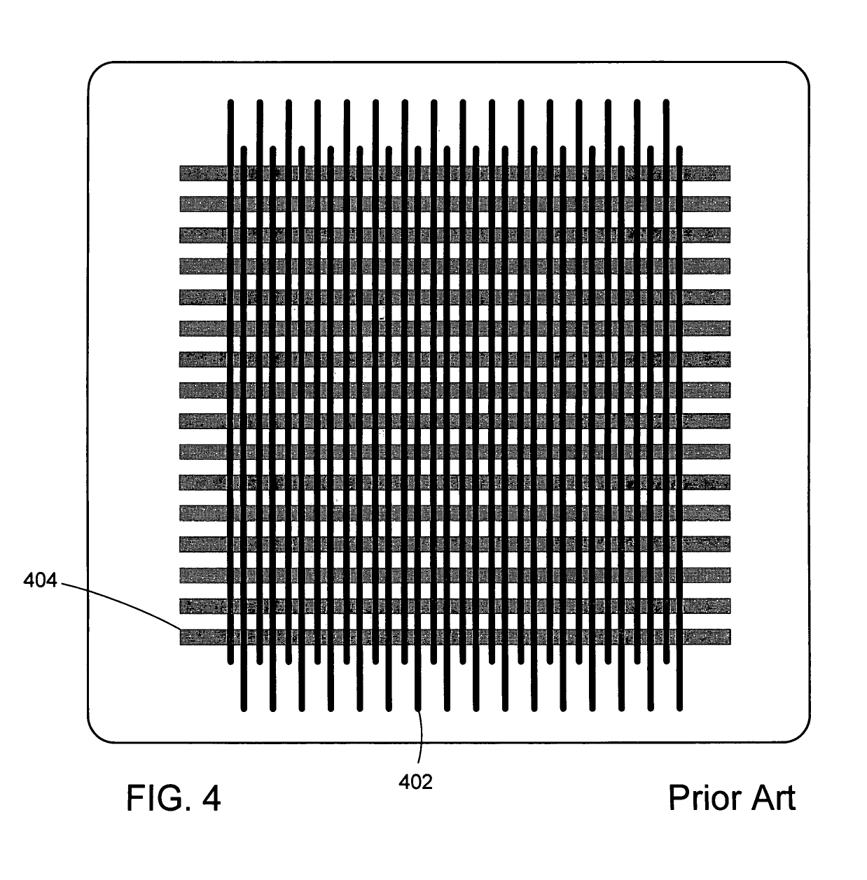

In FIG. 3B, a metal mesh grid is bonded to the cathode structure by screen printing bonding material 312 on top of the metal grid 314 in the area of the dielectric spacer 107. The grid electrode 314 is attached to the cathode by bonding the electrode 314 to the top of the cathode dielectric layer using a bonding material 312, placed on top of the dielectric spacers 107. Holes in the grid 314 allow the bonding material 312 to bond to both the grid 314 and the dielectric spacer material 107. These delicate grid electrodes 314 may be very long (the width of the display) and very thin (approx. 50 microns), and thus, are difficult to handle. FIG. 4 illustrates a top view of the gated, triode electron structure for a carbon nanotube cathode, using a metal mesh grid 404 bonded to cathode dielectric spacers. This top view of a prior art cathode 402 (shown as vertical lines) and metal mesh grid 404 (shown as horizontal lines which correspond to grid electrodes 314 in FIG. 3) structure illustrates the metal mesh grids 404 bonded to the cathode spacers. The metal mesh grid lines 404 go across the length of the display and are on top of the cathode lines 402. The grid lines 404 are electrically isolated from each other. During final assembly of the display, the grid lines and cathode lines are connected to row and column drivers, respectively, for driving the display. The row and column driver connections are typically made with a flextape ribbon cable through appropriate connectors (not shown in figures).

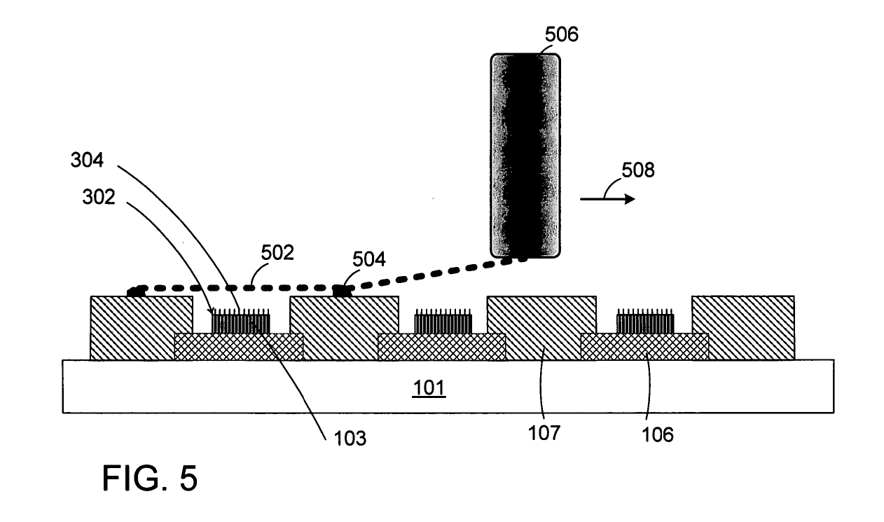

FIG. 5 shows one example method of the present invention: using a wire bonder for fabricating a grid structure. The grid structure may be formed (i.e., stitched) by spooling out and bonding a wire 502, in a direction 508 across the length of the display. The wire 502 may be bonded at each dielectric post 107 between the cathode patches 103. A bonding pad 504 can be placed on top of the dielectric 107 to assist with the bonding by the wire bonding head 506. A step and repeat process can be used to make a full grid structure on the display. In the process of FIG. 5, wire 502 may be continuously dispensed from a strand-like raw material from a spool. The wire may comprise any kind of conducting material, such as a metal, a coated ceramic or polymeric fiber, or even a carbon-nanotube fiber. Composite fibers may be also be used for forming the wire grid electrode array. In one embodiment, the wire grid material is cut and bonded at each bonding pad. By selectively choosing the material and dimensions of the wire grid material, and the spacing and interval of the bonding pads, various kinds of wire grids may be manufactured using the method of the present invention. In one example, the cathode emission current is determined by the selection of the wire grid electrode. In another example, the characteristics of the resulting electron beam, such as scattering and beam coherency, may be tuned by appropriate and corresponding selection of the wire grid material and geometry thereof.

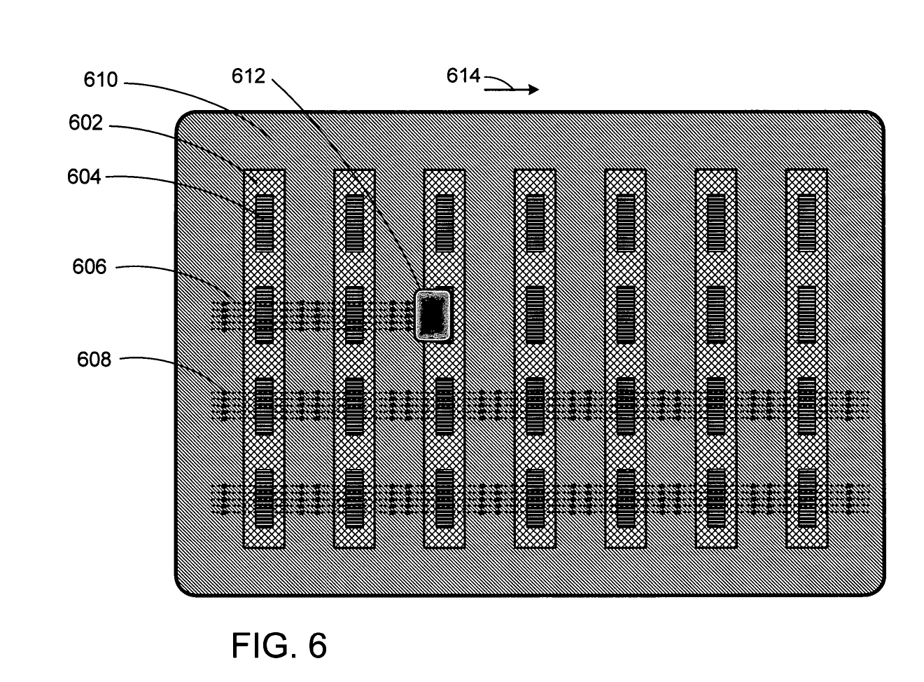

FIG. 6 shows a top view of a grid structure formed in a field emitter display structure in one embodiment of the present invention. A head 612 with multiple wires 606 can be used to improve the speed of making the grid structure, by supplying a continuous feed of wire grid material and bonding it in direction 614. Multiple bonds 608 can be made between the cathode patches. The bonding head 612, as shown in FIG. 6, both dispenses the wire and bonds it to the substrate, although other configurations are possible. In one exemplary instance, the dispensing function and the bonding function may be separate process steps. The pixel wells of a display structure are shown by the conducting cathode lines 602, which are patterned with CNT layers 604. The dielectric layer 610 forms spacers between the pixel wells. The wire may be cut between each cathode patch (not shown in figures), although the electrical contact is continuously maintained across the display, as required in a passive matrix structure. An electrical contact can be provided by a electrically conductive bonding patch 608. In other embodiments of the present invention (not shown in figures), the wires 606 may be bonded together, either transverse or adjacent, to form a mesh-like pattern in the wire grid. The wire may be on the order of 25 microns diameter. The space between the grid wires may be on the order of 25 microns, making the pitch between the wires in each grid row on the order of 50 microns. The gap between the wires and the CNT cathode patch may be also on the order of 25 microns. As this gap grows or shrinks in a field emission display design, the wire size and the pitch between the wires may also grow or shrink. As stated earlier, the wire can be made of any metal or metal alloy material, or combinations of metal and alloys (e.g., inner core and outer core using different materials). It only needs to be conducting, so a dielectric wire with a conductive coating may also be used. Different bonding heads using different bonding mechanisms may also be practiced in embodiments of the present invention. The bonds can be made by ultrasound or laser tacking or by spot welding or by several other means.

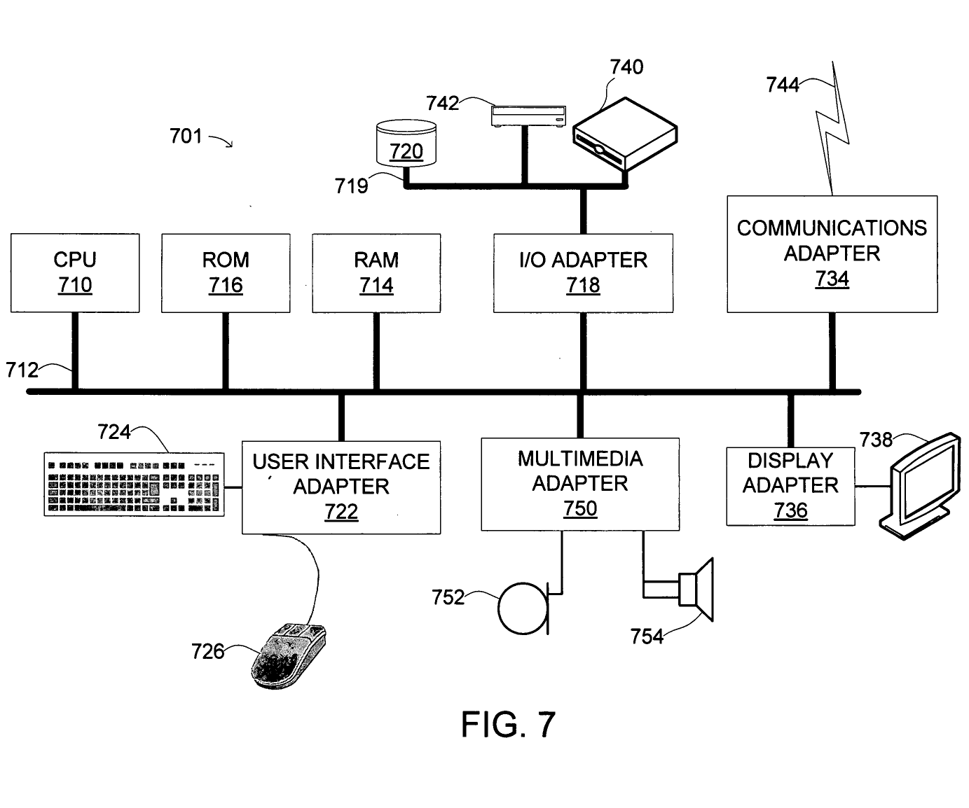

A representative hardware environment for practicing the present invention is depicted in FIG. 7, which illustrates an exemplary hardware configuration of data processing system 701 in accordance with the subject invention having central processing unit (CPU) 710, such as a conventional microprocessor, and a number of other units interconnected via system bus 712. Data processing system 701 includes random access memory (RAM) 714, read only memory (ROM) 716, and input/output (I/O) adapter 718 for connecting peripheral devices such as disk units 720 and tape drives 740 and optical drives 742 to bus 712 via I/O bus 719, user interface adapter 722 for connecting keyboard 724, mouse 726, and/or other user interface devices such as a touch screen device (not shown) to bus 712, communication adapter 734 for connecting data processing system 701 to a data processing network 744, and display adapter 736 for connecting bus 712 to display device 738. Data processing system 701 may further comprise a multimedia adapter 750 for interfacing to a microphone system 752 or speaker system 754, using an analog or digital interface. Speaker system 754 may support multiple loudspeakers for stereo or other advanced sound effects. CPU 710 may include other circuitry not shown herein, which will include circuitry commonly found within a microprocessor, e.g., execution unit, bus interface unit, arithmetic logic unit, etc. Display device 738 represents possible embodiments of the present invention.

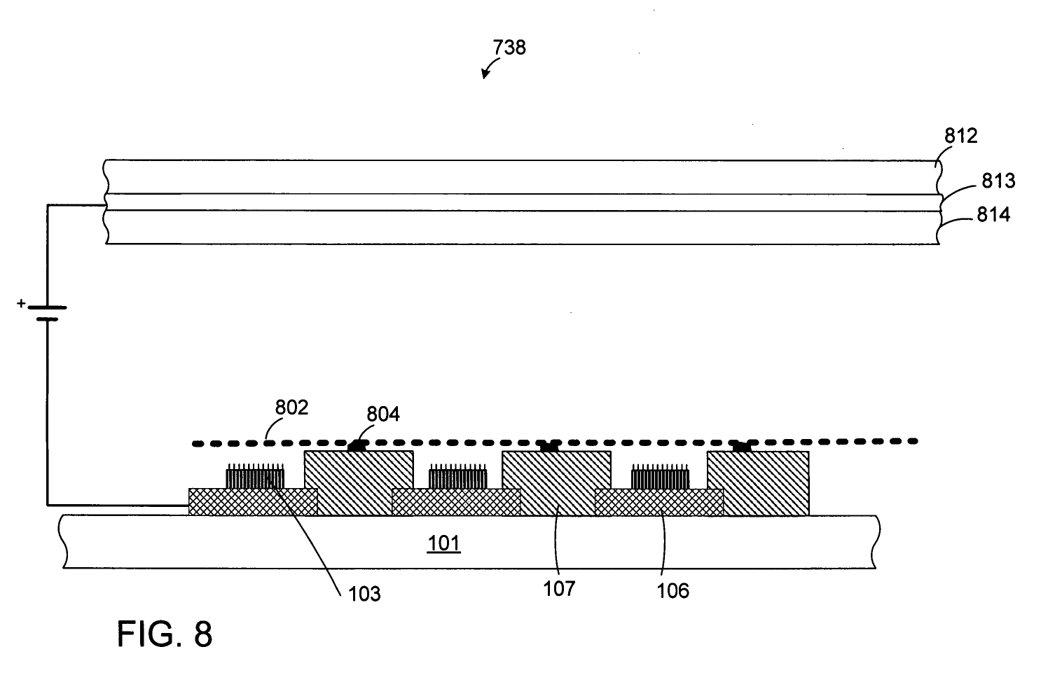

FIG. 8 illustrates a portion of a field emission display 738 made using a cathode in a triode configuration, such as created above. Included with the cathode is a conductive layer 106 and the CNT emitter 103, as well as wire grid 802 and bonding pads 804, which may represent a single, multiple, meshed or other grid electrode configuration. The anode may be comprised, in one particular embodiment, of a glass substrate 812, and indium tin layer 813, and a cathodoluminescent layer 814. An electrical field is set up between the anode and the cathode. The cathodoluminescent (phosphor) layer may be pixelated into red, green, and blue (RGB) phosphors, resulting in a color display. An aluminum metal layer, which is not shown in FIG. 8, may be formed on the surface of the phosphor for improving efficiency and/or luminescent output. Additionally not illustrated in FIG. 8 to preserve clarity are sidewalls, spacers between the anode and cathode/grid plate, exhaust ports, getters and drivers, as well as the interconnects - all of which may comprise an operational field emission display. Such a display 738 could be utilized within a data processing system 701, such as illustrated with respect to FIG. 7.

Although the present invention and its advantages have been described in detail, it should be understood that various changes, substitutions and alterations can be made herein without departing from the spirit and scope of the invention as defined by the appended claims.

What is claimed is:

1. A method of forming an electron field emitter wherein an extraction grid material is dispensed as a fiber.

2. The method of claim 1, wherein said fiber comprises one of a filament, strand, wire, thread, ribbon, or a combination thereof.

3. The method of claim 1, wherein said fiber is dispensed from a spool.

4. The method of claim 1, wherein said fiber is bonded to a surface of said electron field emitter.

5. The method of claim 1, wherein said fiber comprises one of a metal, a polymeric conductor, a ceramic conductor, a carbon-nanotube conductor or a combination thereof.

6. The method of claim 1, wherein said fiber is continuously dispensed in a bonding process.

7. The method of claim 1, wherein a plurality of fibers are simultaneously dispensed and bonded to a surface of said electron field emitter.

8. The method of claim 1, wherein said fiber is cut during the bonding process.

9. The method of claim 1, wherein adjacent fibers are bonded together.

10. A method of forming an electron field emitter wherein an extraction grid comprises an electrode formed by bonding a fiber suspended over a field emitter cathode.

11. The method of claim 10, wherein said fiber comprises one of a filament, strand, wire, thread, ribbon, or a combination thereof.

12. The method of claim 10, wherein said fiber is dispensed from a spool.

13. The method of claim 10, wherein said fiber comprises one of a metal, a polymeric conductor, a ceramic conductor, a carbon-nanotube conductor or a combination thereof.

14. The method of claim 10, wherein said fiber is continuously dispensed in a bonding process.

15. The method of claim 10, wherein a plurality of fibers are simultaneously dispensed and bonded to a surface of said field emitter cathode.

16. The method of claim 10, wherein said fiber is cut during the bonding process.

17. The method of claim 10, wherein adjacent fibers are bonded together.
